(19) United States
(12) Patent Application Publication
(10) Pub. No.: US 2012/0106509 A1
(43) Pub. Date: May 3, 2012

(54) DATA REPROCESSING IN RADIO PROTOCOL LAYERS

(76) Inventors: Thomas Klingenbrunn, San Diego, CA (US); Shailesh Maheshwari, San Diego, CA (US)

(21) Appl. No.: 13/281,258

(22) Filed: Oct. 25, 2011

Related U.S. Application Data
(60) Provisional application No. 61/407,305, filed on Oct. 27, 2010.

(51) Int. Cl. H04W 36/14; H04W 36/18; H04W 12/00; H04W 40/00

(52) U.S. Cl. 370/331; 370/310

(57) ABSTRACT

A method for reprocessing data in a radio protocol layer is described. The method includes communicating using a first radio access technology. Data in a processed data buffer of a first radio access technology protocol layer is reprocessed. The reprocessed data is forwarded to an unprocessed data buffer. A trigger for a handover from the first radio access technology to a second radio access technology may be detected. A trigger for a radio connection release may also be detected.

### RELATED APPLICATIONS

This application is related to and claims priority from U.S. Provisional Patent Application Ser. No. 61/407,305, filed Oct. 27, 2010, for “Mechanism for Data-Forwarding Between Radio Protocol Stacks During Inter-Radio-Access-Technology (IRAT) Transitions.”

### TECHNICAL FIELD

The present disclosure relates generally to wireless communication systems. More specifically, the present disclosure relates to systems and methods for data reprocessing in radio protocol layers.

### BACKGROUND

Wireless communication systems are widely deployed to provide various types of communication content such as voice, video, data and so on. These systems may be multiple-access systems capable of supporting simultaneous communication of multiple mobile devices with one or more base stations.

As wireless communication systems have become more widely deployed, the number of radio access technologies (RATs) available has also increased. To increase the feasibility and mobility of a mobile device, the mobile device may be capable of communicating using more than one radio access technology (RAT). As the data rates increase for these radio access technologies (RATs), a considerable amount of data may be processed within a relatively short amount of time. If this data is lost, the user experience may suffer as data rates are diminished. Benefits may be realized by improved methods for communicating with more than one radio access technology (RAT) to reduce the possibility of diminished data rates.

### SUMMARY

A method for reprocessing data in a radio protocol layer is described. The method includes communicating using a first radio access technology. Data in a processed data buffer of a first radio access technology protocol layer is reprocessed. The reprocessed data is forwarded to an unprocessed data buffer.

The method may include transitioning to communicating using a second radio access technology. The reprocessed data may be forwarded for transmission on the second radio access technology. A trigger for a handover from the first radio access technology to a second radio access technology may be detected. The unprocessed data buffer may be part of a second radio access technology protocol layer. Data in an unprocessed data buffer of the first radio access technology protocol layer may be forwarded to the unprocessed data buffer of the second radio access technology protocol layer. A radio connection release may be detected. The unprocessed data buffer may be part of the first radio access technology protocol layer. A connection to a second radio access technology may be established after the radio connection release.

Reprocessing data in the processed data buffer may include at least one of uncompressing compressed headers of IP packets, deciphering packets which have been ciphered for security protection, removing protocol layer specific headers, undoing segmentation and undoing concatenation. The data in the processed data buffer may have passed through a packet data convergence protocol layer. The reprocessed data may be in a same state as data provided to an unprocessed data buffer by a data services layer.

The data that is reprocessed may be limited. Limiting the data that is reprocessed may include dropping all packets in the processed data buffer that have been in the processed data buffer longer than a drop packet threshold. Limiting the data that is reprocessed may also include carrying over a time spent in the processed data buffer for each packet of the data forwarded to the unprocessed data buffer. The method may be performed by a wireless communication device.

A wireless device configured for reprocessing data in a radio protocol layer is also described. The wireless device includes a processor, memory in electronic communication with the processor and instructions stored in the memory. The instructions are executable by the processor to communicate using a first radio access technology. The instructions are also executable by the processor to reprocess data in a processed data buffer of a first radio access technology protocol layer. The instructions are further executable by the processor to forward the reprocessed data to an unprocessed data buffer.

A wireless device configured for reprocessing data in a radio protocol layer is described. The wireless device includes means for communicating using a first radio access technology. The wireless device also includes means for reprocessing data in a processed data buffer of a first radio access technology protocol layer. The wireless device further includes means for forwarding the reprocessed data to an unprocessed data buffer.

A computer-program product for reprocessing data in a radio protocol layer is also described. The computer-program product includes a non-transitory computer-readable medium having instructions thereon. The instructions include code for causing a wireless device to communicate using a first radio access technology. The instructions also include code for causing the wireless device to reprocess data in a processed data buffer of a first radio access technology protocol layer. The instructions further include code for causing the wireless device to forward the reprocessed data to an unprocessed data buffer.

### BRIEF DESCRIPTION OF THE DRAWINGS

FIG. 1 shows a wireless communication system with multiple wireless devices;

FIG. 2 is a block diagram illustrating various types of connectivity between a user equipment (UE) and a core network that the user equipment (UE) may utilize for data services and/or voice services;

FIG. 3 is a block diagram illustrating a radio traffic stack for use in the present systems and methods;

FIG. 4 is a flow diagram illustrating a method for forwarding data between a first radio access technology (RAT) protocol layer and a second radio access technology (RAT) protocol layer after a handover from the first radio access technology (RAT) to the second radio access technology (RAT) has been triggered;

FIG. 5 is a block diagram illustrating another radio traffic stack for use in the present systems and methods;

FIG. 6 is a flow diagram illustrating of a method for reprocessing data in a processed data buffer after a radio connection release;

FIG. 7 is a flow diagram illustrating a method for limiting which data is reprocessed; and

FIG. 8 illustrates certain components that may be included within a wireless communication device.

### DETAILED DESCRIPTION

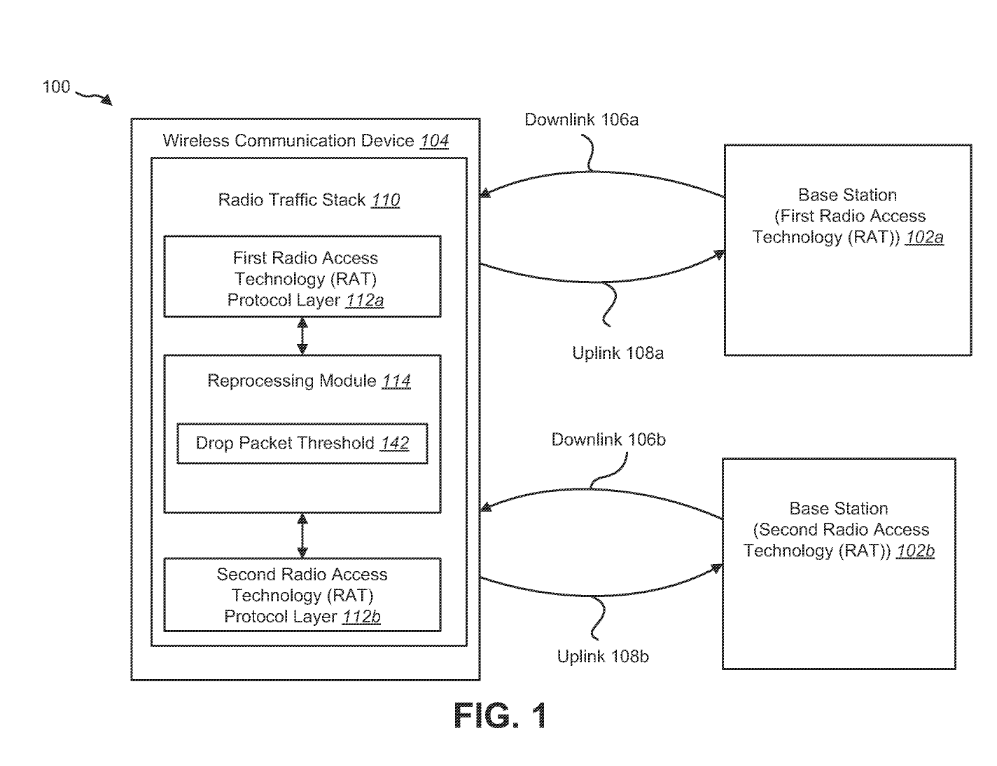

FIG. 1 shows a wireless communication system 100 with multiple wireless devices. Wireless communication systems 100 are widely deployed to provide various types of communication content such as voice, data and so on. A wireless device may be a base station 102a-b or a wireless communication device 104.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 106a-b and/or uplink 108a-b at any given moment. The downlink 106 (or forward link) refers to the communication link from a base station 102 to a wireless communication device 104, and the uplink 108 (or reverse link) refers to the communication link from a wireless communication device 104 to a base station 102.

A wireless communication device 104 may be capable of communicating with a first base station 102a as part of a first radio access technology (RAT) and a second base station 102b as part of a second radio access technology (RAT). Examples of radio access technologies (RATs) include Global System for Mobile Communications (GSM), 1× (also known as cdma2000 1×), high data rate (HDR), W-CDMA and Long Term Evolution (LTE). The first base station 102a may use a different radio access technology (RAT) than the second base station 102b.

The wireless communication device 104 may include a radio traffic stack 110. The radio traffic stack 110 may facilitate wireless communications by the wireless communication device 104. The radio traffic stack 110 may include a first radio access technology (RAT) protocol layer 112a for communications using the first radio access technology (RAT) and a second radio access technology (RAT) protocol layer 112b for communications using the second radio access technology (RAT). The radio traffic stack 110 may include additional radio access technology (RAT) protocol layers 112 for additional radio access technologies (RATs).

In one configuration, the wireless communication device 104 may transition from the first radio access technology (RAT) to the second radio access technology (RAT). In another configuration, the radio connection for the first radio access technology (RAT) may be released. The radio connection for the first radio access technology (RAT) may be released because the wireless communication device 104 has temporarily moved out of coverage while transitioning from the first radio access technology (RAT) to establishing a connection with the second radio access technology (RAT). The radio connection for the first radio access technology (RAT) may also be released due to a trigger from the network (e.g., if the network cannot decode a signal from the wireless communication device 104) or due to a local trigger (e.g., if the wireless communication device 104 cannot decode a signal from the network).

If the wireless communication device 104 transitions from the first radio access technology (RAT) to the second radio access technology (RAT) or if the radio connection for the first radio access technology (RAT) is released, the data that is already being processed by the wireless communication device 104 for the first radio access technology (RAT) is considered lost after the transition/connection release. This is because the data has already been submitted to lower layers in the first radio access technology (RAT) protocol layer 112a. In the lower layers of the first radio access technology (RAT) protocol layer 112a, the data may have been subjected to several operations, including header compression, ciphering, header insertion and segmentation/concatenation.

Typically, retrieving data from the lower layers in the first radio access technology (RAT) protocol layer 112a, which includes undoing any operations already performed on the data, may be associated with considerable processing complexity. For radio access technologies (RATs) such as 3G and 4G technologies, the amount of data that could get lost is considerable. An end user may experience a sudden drop in data rate if the data in the lower layers of the first radio access technology (RAT) protocol layer 112a is dropped after a transition/connection release. Even worse, the data may have to be retransmitted at higher layers, such as the transmission control protocol (TCP) layer, which can aggravate the problem of data loss by employing congestion control mechanisms to slow down the data rate, leading to a further degraded end user experience. If the data is reprocessed rather than dropped, data loss during inter radio access technology (IRAT) mobility may be reduced. In addition, transmission control protocol (TCP) backoff may be prevented, which might otherwise slow down the data transfer and adversely impact the end user experience. Thus, even though considerable processing complexity is encountered, the transmission control protocol (TCP) performance may be improved. Normally, handovers occur in poor radio conditions, such that the data rates are considerably lower than peak data rates (and thus the additional processing should fit in the CPU/MIPS budget).

The wireless communication device 104 may include a reprocessing module 114. The reprocessing module 114 may reprocess the data that would otherwise be lost due to a transition/connection release. When a handover from the first radio access technology (RAT) to the second radio access technology (RAT) is triggered, the reprocessing module 114 may reprocess the data that is sitting in a processed data buffer in the first radio access technology (RAT) protocol layer 112a. This reprocessed data (i.e., data back in the original state) may then be forwarded to the upper layers (i.e., an unprocessed data buffer) of the second radio access technology (RAT) protocol layer 112b in the radio traffic stack 110. Likewise, when a radio connection is released for the first radio access technology (RAT), the reprocessing module 114 may reprocess the data that is sitting in the processed data buffer of the first radio access technology (RAT) protocol layer 112a. This reprocessed data may then be forwarded back to upper layers (i.e., an unprocessed data buffer) in the first radio access technology (RAT) protocol layer 112a.

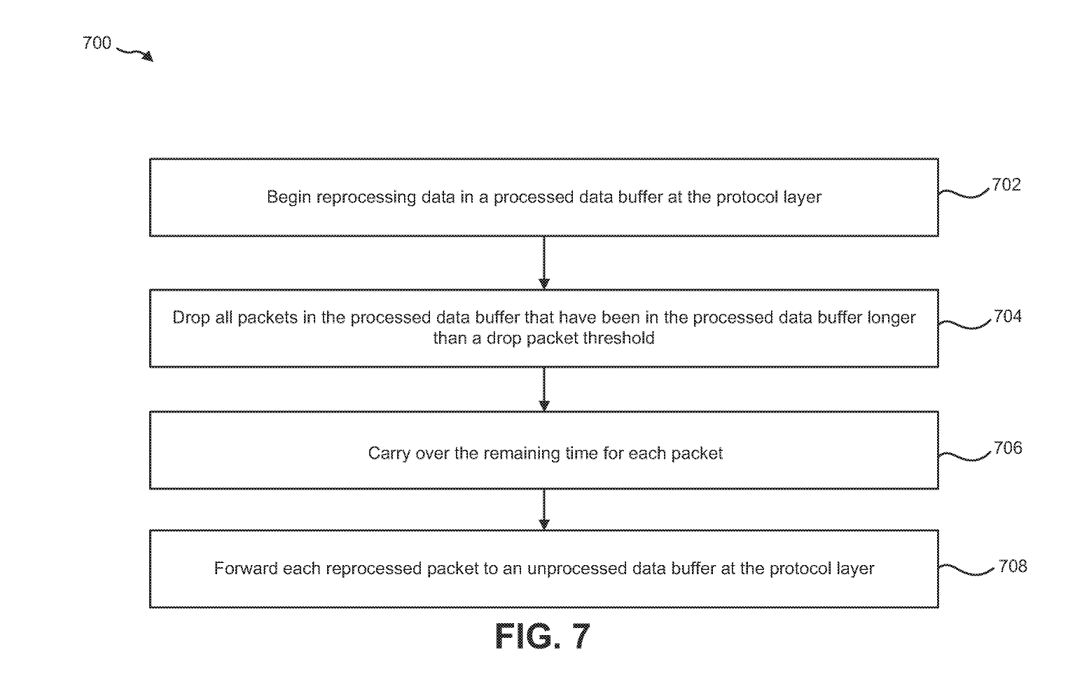

In some configurations, it may be beneficial for the reprocessing module 114 to limit the data that is reprocessed. The reprocessing module 114 may include a drop packet threshold 142. When the reprocessing module 114 begins reprocessing data at the protocol layer, the reprocessing module 114 may drop all packets in the processed data buffer that have been in the processed data buffer longer than the drop packet threshold 142. The drop packet threshold 142 is discussed in additional detail below in relation to FIG. 7.

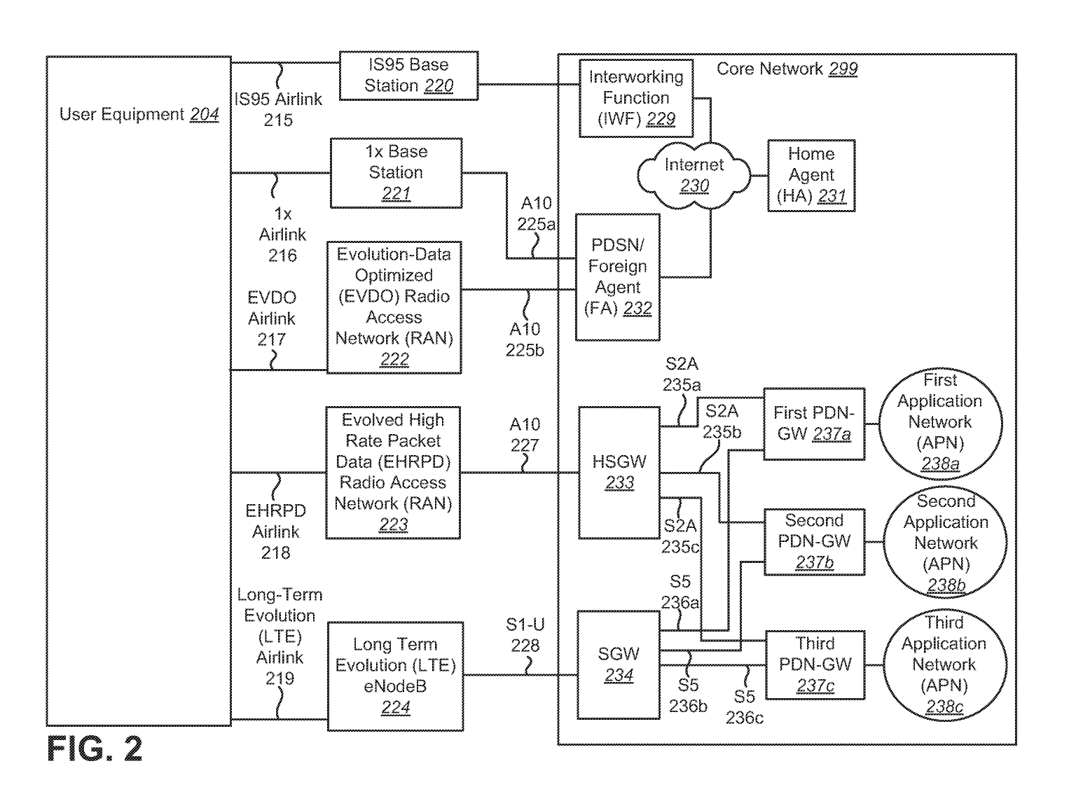

FIG. 2 is a block diagram illustrating various types of connectivity between a user equipment (UE) 204 and a core network 299 that the user equipment (UE) 204 may utilize for data services and/or voice services. The user equipment 204 of FIG. 2 may be one configuration of the wireless communication device 104 of FIG. 1. Multiple air interfaces (or airlinks) may provide a data connection for a user equipment (UE) 204 to the Internet 230 via an Interim Standard 95 (IS95) base station 220, a CDMA 2000 1× (referred to herein as “1×”, may also be referred to as IS-2000 or 1× RTT) base station 221 and/or an Evolution-Data Optimized (EVDO) radio access network (RAN) 222. The IS95 base station 220 may provide an IS95 airlink 215 for the user equipment (UE) 204. The IS95 base station 220 may be connected to the Internet 230 via an InterWorking Function (IWF) 229. The 1× base station 221 may provide a 1× airlink 216 to the user equipment (UE) 204. The Evolution-Data Optimized (EVDO) radio access network (RAN) 222 may provide an Evolution-Data Optimized (EVDO) airlink 217 to the user equipment (UE) 204. The 1× base station 221 and Evolution-Data Optimized (EVDO) radio access network (RAN) 222 may be connected via A10 interfaces 225a-b to a Packet Data Serving Node (PDSN) 232, which in turn is connected to the Internet 230. The Packet Data Serving Node (PDSN) 232 may include a Foreign Agent (FA). A Home Agent (HA) 231 may be connected to the Internet 230.

The network architecture may include data connectivity via the evolved high rate packet data (EHRPD) airlink 218 and an evolved high rate packet data (EHRPD) radio access network (RAN) 223 to the core network 299. The evolved high rate packet data (EHRPD) radio access network (RAN) 223 may employ an A10 interface 227 to connect to an HRPD Serving Gateway (HSGW) 233. The network architecture may also include data connectivity via the Long Term Evolution (LTE) airlink 219 and Long Term Evolution (LTE) eNodeB 224. The Long Term Evolution (LTE) eNodeB 224 may employ an S1-U interface 228 to connect to a Serving Gateway (SGW) 234. The HRPD Serving Gateway (HSGW) 233 may connect to a first Packet Data Network Gateway (PDN-GW) 237a, a second Packet Data Network Gateway (PDN-GW) 237b and a third Packet Data Network Gateway (PDN-GW) 237c via S2A interfaces 235a-c. The Serving Gateway (SGW) 234 may connect with the first Packet Data Network Gateway (PDN-GW) 237a, the second Packet Data Network Gateway (PDN-GW) 237b and the third Packet Data Network Gateway (PDN-GW) 237c via S5 interfaces 236a-c. The first Packet Data Network Gateway (PDN-GW) 237a may connect to a first Application Network (APN) 238a. The second Packet Data Network Gateway (PDN-GW) 237b may connect to a second Application Network (APN) 238b. The third Packet Data Network Gateway (PDN-GW) 237c may connect to a third Application Network (APN) 238c. An Application Network (APN) 238 may include, but is not limited to, an Internet Multimedia System (IMS) that a user equipment (UE) 204 connects to for obtaining Voice over IP (VoIP) or video telephony services or an Administrative Application Network (APN) the user equipment (UE) 204 may establish a connection with in order to download configuration information for the user equipment (UE) 204.

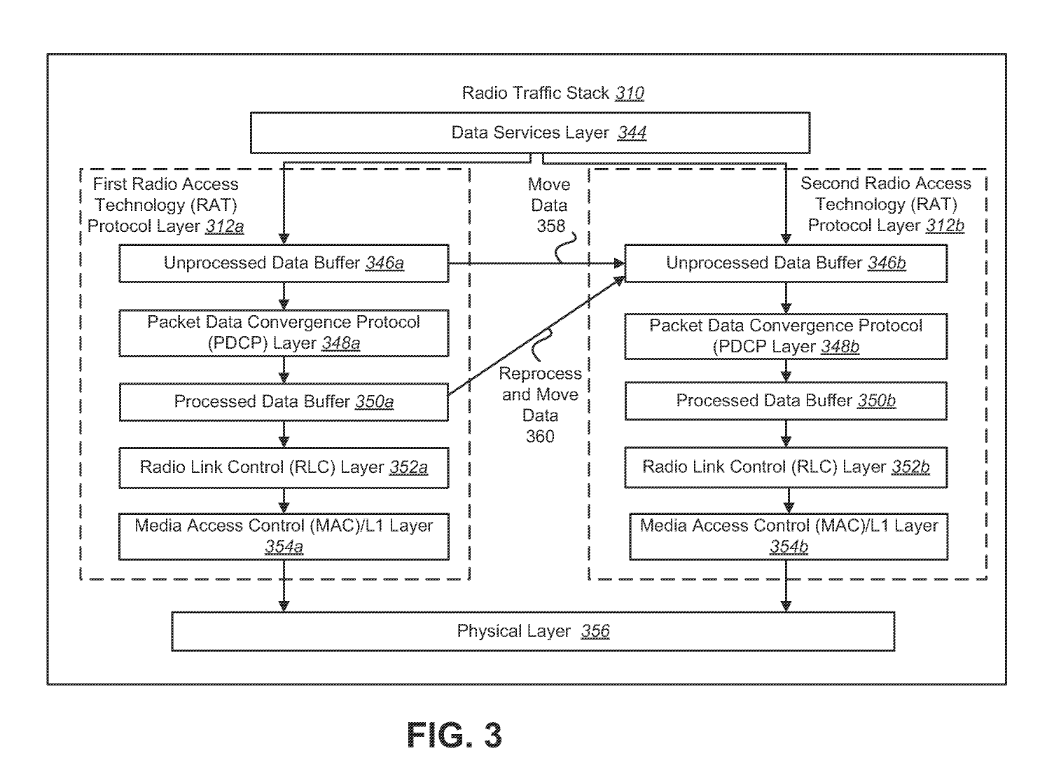

FIG. 3 is a block diagram illustrating a radio traffic stack 310 for use in the present systems and methods. The radio traffic stack 310 of FIG. 3 may be one configuration of the radio traffic stack 110 of FIG. 1. The radio traffic stack 310 may include a data services layer 344, a first radio access technology (RAT) protocol layer 312a, a second radio access technology (RAT) protocol layer 312b and a physical layer 356. Data to be transmitted is moved from the data services layer 344 through the appropriate radio access technology (RAT) protocol layer 312 and then to the physical layer 356. For example, if the wireless communication device 104 is communicating using a first radio access technology (RAT), the first radio access technology (RAT) protocol layer 312a may be active.

The first radio access technology (RAT) protocol layer 312a may include an unprocessed data buffer 346a, a packet data convergence protocol (PDCP) layer 348a, a processed data buffer 350a, a radio link control (RLC) layer 352a and a media access control (MAC)/L1 layer 354a. Likewise, the second radio access technology (RAT) protocol layer 312b may include an unprocessed data buffer 346b, a packet data convergence protocol (PDCP) layer 348b, a processed data buffer 350b, a radio link control (RLC) layer 352b and a media access control (MAC)/L1 layer 354b. During a transition from the first radio access technology (RAT) to the second radio access technology (RAT), the data that is in the unprocessed data buffer 346a of the first radio access technology (RAT) protocol layer 312a is moved 358 to the unprocessed data buffer 346b of the second radio access technology (RAT) protocol layer 312b. The data in the processed data buffer 350a of the first radio access technology (RAT) protocol layer 312b has traditionally been considered lost. However, in the present systems and methods, the data in the processed data buffer 350a of the first radio access technology (RAT) protocol layer 312a is reprocessed by the reprocessing module 314 and moved 360 to the unprocessed data buffer 346b of the second radio access technology (RAT) protocol layer 312b.

Reprocessing the data in the processed data buffer 350a may include uncompressing compressed headers of IP packets that were compressed using, for example, internet protocol header compression (IPHC) or robust header compression (RoHC). Reprocessing the data in the processed data buffer 350a may also include deciphering packets which have been ciphered for security protection. Reprocessing the data in the processed data buffer 350a may further include removing protocol layer specific headers (e.g., for sequence number and packet classification). Reprocessing the data in the processed data buffer 350a may also include undoing segmentation/concatenation processing. Thus, the data that is moved 360 from the processed data buffer 350a of the first radio access technology (RAT) protocol layer 312a to the unprocessed data buffer 346b of the second radio access technology (RAT) protocol layer 312b has been returned to the original state (i.e., the state of the data when it was in the unprocessed data buffer 346a of the first radio access technology (RAT) protocol layer 312a).

Certain restrictions may be placed on which data in the processed data buffer 350a of the first radio access technology (RAT) protocol layer 312a is reprocessed. For example, data that is deemed stale (e.g., data that may be deleted in the second radio access technology (RAT) protocol layer 312b) may be selectively ignored by the reprocessing module 314 (and thus not forwarded to the second radio access technology (RAT) protocol layer 312b). Several methods may be used for limiting the data in the processed data buffer 350a of the first radio access technology (RAT) protocol layer 312a that is reprocessed. The reprocessing module 114 may carry over the time spent in the processed data buffer 350a for each packet and let the second radio access technology (RAT) protocol layer 312b drop a packet if it is not transmitted within the drop packet threshold 142. Limiting which data is reprocessed is discussed in additional detail below in relation to FIG. 7.

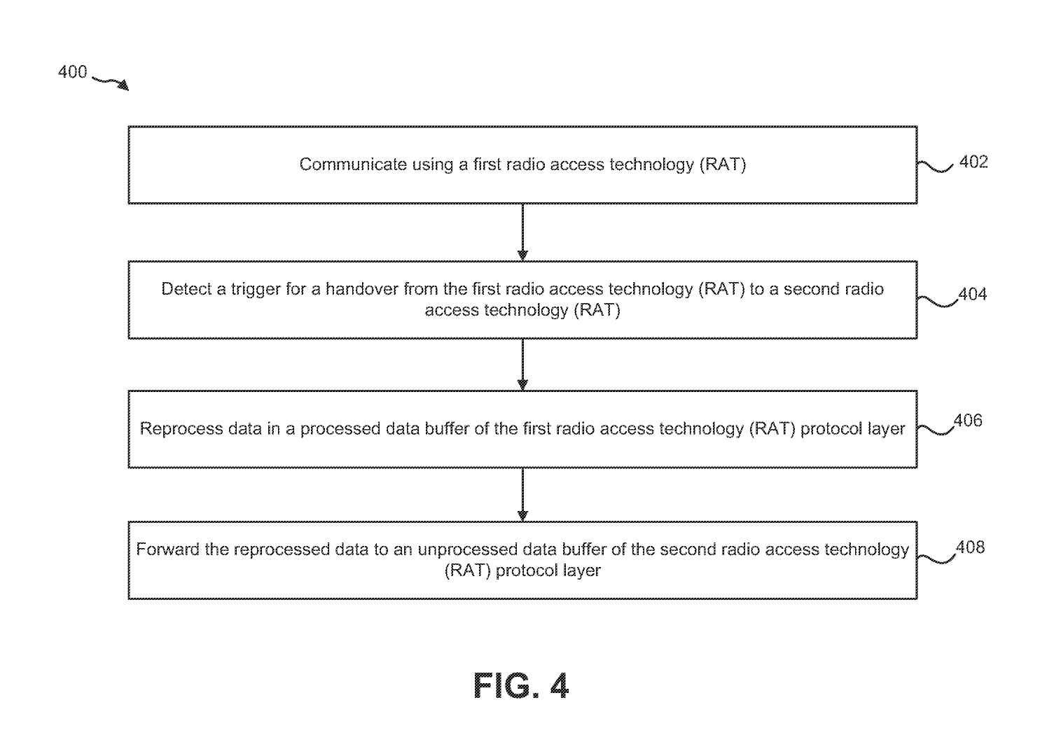

FIG. 4 is a flow diagram illustrating a method 400 for forwarding data between a first radio access technology (RAT) protocol layer 112a and a second radio access technology (RAT) protocol layer 112b after a handover from the first radio access technology (RAT) to the second radio access technology (RAT) has been triggered. The method 400 may be performed by a wireless communication device 104. The wireless communication device 104 may communicate 402 using a first radio access technology (RAT). The wireless communication device 104 may detect 404 a trigger for a handover from the first radio access technology (RAT) to a second radio access technology (RAT).

The wireless communication device 104 may reprocess 406 data in a processed data buffer 350a of the first radio access technology (RAT) protocol layer 112a. The data in the processed data buffer 350a may have already been subjected to several operations within the first radio access technology (RAT) protocol layer 112a, such as header compression, ciphering, header insertion, segmentation and concatenation. The reprocessing 406 may undo any processing that was done on the data, such that the reprocessed data is in the same state as when it entered the first radio access technology (RAT) protocol layer 112a. Reprocessing 406 may undo the specific processing performed by the first radio access technology (RAT) protocol layer 312a, so that the original raw data is recovered byte-for-byte. For example, reprocessing 406 may include uncompressing compressed headers, deciphering packets that have been ciphered, removing protocol layer specific headers, undoing segmentation and undoing concatenation. The wireless communication device 104 may then forward 408 the reprocessed data to an unprocessed data buffer 346b of the second radio access technology (RAT) protocol layer 112b. The forwarded data is subsequently processed in accordance with the protocols of the second radio access technology (RAT).

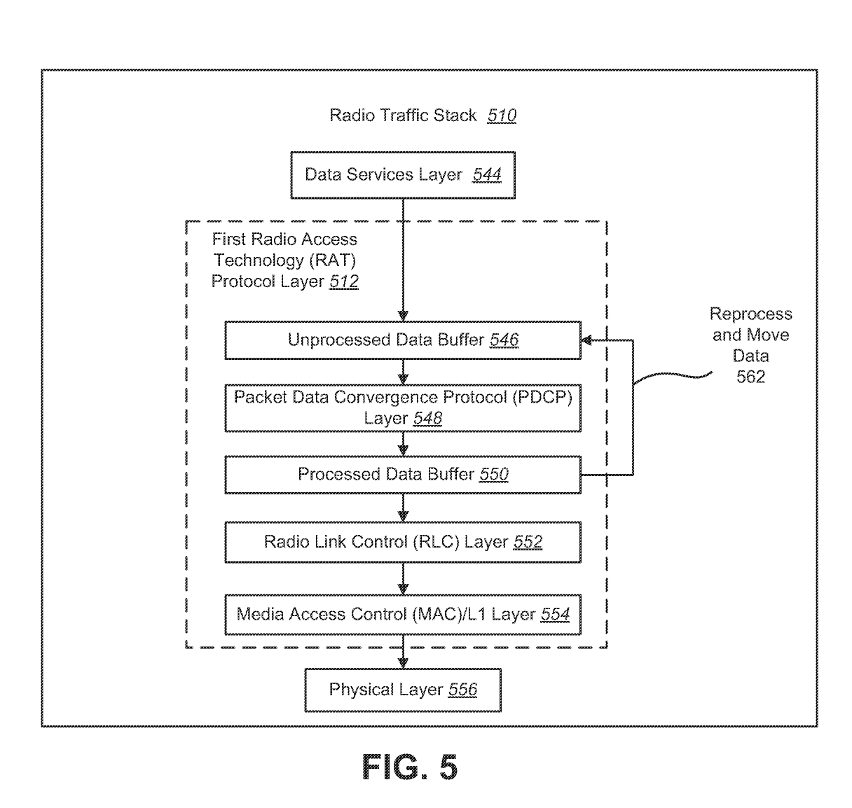

FIG. 5 is a block diagram illustrating another radio traffic stack 510 for use in the present systems and methods. The radio traffic stack 510 of FIG. 5 may be one configuration of the radio traffic stack 110 of FIG. 1. The radio traffic stack 510 may include a data services layer 544, a first radio access technology (RAT) protocol layer 512 and a physical layer 556. Data to be transmitted is moved from the data services layer 544 through the first radio access technology (RAT) protocol layer 512 and then to the physical layer 556.

The first radio access technology (RAT) protocol layer 512 may include an unprocessed data buffer 546, a packet data convergence protocol (PDCP) layer 548, a processed data buffer 550, a radio link control (RLC) layer 552 and a media access control (MAC)/L1 layer 554. When a data connection is released, the data that is in the processed data buffer 550 of the first radio access technology (RAT) protocol layer 512 has traditionally been considered lost. However, in the present systems and methods, the data in the processed data buffer 550 of the first radio access technology (RAT) protocol layer 512 may be reprocessed by the reprocessing module 114 and moved 562 to the unprocessed data buffer 546 of the first radio access technology (RAT) protocol layer 512.

Reprocessing the data in the processed data buffer 550 may include uncompressing compressed headers of IP packets that were compressed using, for example, internet protocol header compression (IPHC) or robust header compression (RoHC). Reprocessing the data in the processed data buffer 550 may also include deciphering packets which have been ciphered for security protection. Reprocessing the data in the processed data buffer 550 may further include removing protocol layer specific headers (e.g., for sequence number and packet classification). Reprocessing the data in the processed data buffer 550 may also include undoing segmentation/concatenation processing. Thus, the data that is moved from the processed data buffer 550 of the first radio access technology (RAT) protocol layer 512 to the unprocessed data buffer 546 of the first radio access technology (RAT) protocol layer 512 has been returned to the original state (i.e., the state of the data when it originally entered the unprocessed data buffer 546 of the first radio access technology (RAT) protocol layer 512).

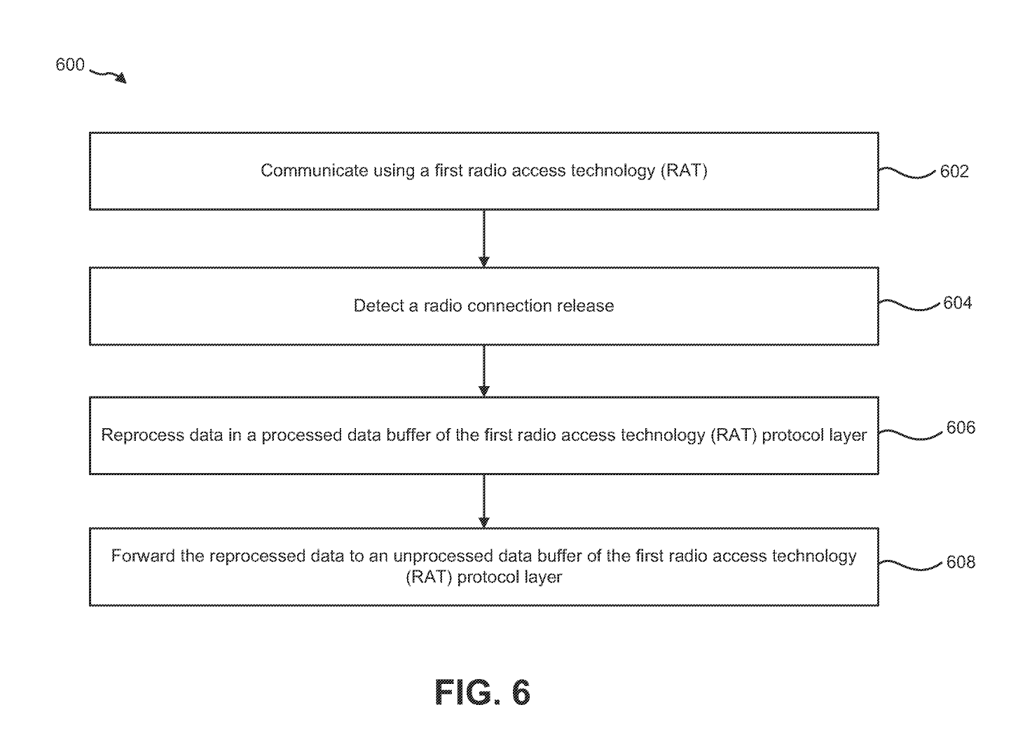

FIG. 6 is a flow diagram illustrating of a method 600 for reprocessing data in a processed data buffer 550 after a radio connection release. The method 600 may be performed by a wireless communication device 104. The wireless communication device 104 may communicate 602 using a first radio access technology (RAT). The wireless communication device 104 may detect 604 a radio connection release. The wireless communication device 104 may reprocess 606 data in a processed data buffer 550 of the first radio access technology (RAT) protocol layer 512. As discussed above, reprocessing 606 data may include uncompressing compressed headers, deciphering packets that have been ciphered, removing protocol layer specific headers, undoing segmentation and undoing concatenation. The wireless communication device 104 may then forward 608 the reprocessed data to an unprocessed data buffer 546 of the first radio access technology (RAT) protocol layer 512.

As discussed above, certain restrictions may be placed on which data in the processed data buffer 550 of the first radio access technology (RAT) protocol layer 512 is reprocessed. In one configuration, discussed in additional detail below in relation to FIG. 7, the reprocessing module 114 may carry over the time spent in the processed data buffer 550 for each packet and let the unprocessed data buffer 546 at the protocol layer drop the packet if it is not transmitted within a drop packet threshold 142.

FIG. 7 is a flow diagram illustrating a method 700 for limiting which data is reprocessed. The method 700 may be performed by a wireless communication device 104. In one configuration, the method 700 may be performed by a reprocessing module 114 as part of the radio traffic stack 110 of the wireless communication device 104. The wireless communication device 104 may begin 702 reprocessing data in a processed data buffer 350 at the protocol layer. The processed data buffer 350a may be part of a first radio access technology (RAT) protocol layer 312a. In one configuration, the wireless communication device 104 may begin 702 reprocessing data in the processed data buffer 350a in response to detecting a trigger for a handover from a first radio access technology (RAT) to a second radio access technology (RAT). In another configuration, the wireless communication device 104 may begin 702 reprocessing data in the processed data buffer 350a in response to a radio connection release.

The wireless communication device 104 may drop 704 all packets in the processed data buffer 350a that have been in the processed data buffer 350a longer than a drop packet threshold 142. The wireless communication device 104 may carry 706 over the time spent in the processed data buffer 350a for each packet. To carry 706 over the time spent in the processed data buffer 350a for each packet refers to remembering the timestamp of the packet, in case there are multiple back-to-back inter radio access technology (IRAT) transitions. If the time spent in the processed data buffer 350 for each packet is not carried 706 over, a stale packet may end up being forwarded repeatedly, as the timestamp is continually reset.

The wireless communication device 104 may forward 708 each reprocessed packet to an unprocessed data buffer 346 at the protocol layer. If the wireless communication device 104 begins 702 reprocessing data in the processed data buffer 350a in response to detecting a trigger for a handover from a first radio access technology (RAT) to a second radio access technology (RAT), the unprocessed data buffer 346b may be part of the second radio access technology (RAT) protocol layer 312b. If the wireless communication device 104 begins reprocessing data in the processed data buffer 350a in response to a radio connection release, the unprocessed data buffer 346a may be part of the first radio access technology (RAT) protocol layer 312a.

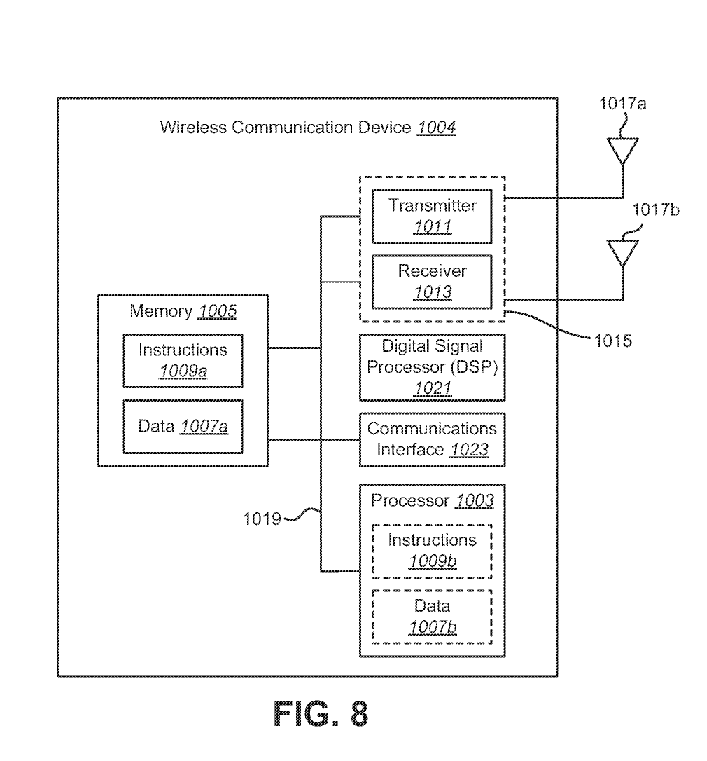

FIG. 8 is a flow diagram illustrating another method 800 for limiting which data is reprocessed. The method 800 may be performed by a wireless communication device 104. In one configuration, the method 800 may be performed by a reprocessing module 114 as part of the radio traffic stack 110 of the wireless communication device 104. The wireless communication device 104 may begin 802 reprocessing data in a processed data buffer 350a at the protocol layer. The processed data buffer 350a may be part of a first radio access technology (RAT) protocol layer 312a. In one configuration, the wireless communication device 104 may begin 802 reprocessing data in the processed data buffer 350a in response to detecting a trigger for a handover from a first radio access technology (RAT) to a second radio access technology (RAT). In another configuration, the wireless communication device 104 may begin 802 reprocessing data in the processed data buffer 350a in response to a radio connection release.

The wireless communication device 104 may drop 804 all packets in the processed data buffer 350a that have been in the processed data buffer longer than a drop packet threshold 142. The wireless communication device 104 may forward 806 each reprocessed packet to an unprocessed data buffer 346 at the protocol layer. If the wireless communication device 104 begins 802 reprocessing data in the processed data buffer 350a in response to detecting a trigger for a handover from a first radio access technology (RAT) to a second radio access technology (RAT), the unprocessed data buffer 346b may be part of the second radio access technology (RAT) protocol layer 312b. If the wireless communication device 104 begins 802 reprocessing data in the processed data buffer 350a in response to a radio connection release, the unprocessed data buffer 346a may be part of the first radio access technology (RAT) protocol layer 312a.

FIG. 8 illustrates certain components that may be included within a wireless communication device 1004. The wireless communication device 1004 may be an access terminal, a mobile station, a user equipment (UE), etc. The wireless communication device 1004 includes a processor 1003. The processor 1003 may be a general purpose single- or multi-chip microprocessor (e.g., an ARM), a special purpose microprocessor (e.g., a digital signal processor (DSP)), a microcontroller, a programmable gate array, etc. The processor 1003 may be referred to as a central processing unit (CPU). Although just a single processor 1003 is shown in the wireless communication device 1004 of FIG. 8, in an alternative configuration, a combination of processors (e.g., an ARM and DSP) could be used.

The wireless communication device 1004 also includes memory 1005. The memory 1005 may be any electronic component capable of storing electronic information. The memory 1005 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1007a and instructions 1009a may be stored in the memory 1005. The instructions 1009a may be executable by the processor 1003 to implement the methods disclosed herein. Executing the instructions 1009a may involve the use of the data 1007a that is stored in the memory 1005. When the processor 1003 executes the instructions 1009a, various portions of the instructions 1009b may be loaded onto the processor 1003, and various pieces of data 1007b may be loaded onto the processor 1003.

The wireless communication device 1004 may also include a transmitter 1011 and a receiver 1013 to allow transmission and reception of signals to and from the wireless communication device 1004. The transmitter 1011 and receiver 1013 may be collectively referred to as a transceiver 1015. Multiple antennas 1017a-b may be electrically coupled to the transceiver 1015. The wireless communication device 1004 may also include (not shown) multiple transmitters, multiple receivers, multiple transceivers and/or additional antennas.

The wireless communication device 1004 may include a digital signal processor (DSP) 1021. The wireless communication device 1004 may also include a communications interface 1023. The communications interface 1023 may allow a user to interact with the wireless communication device 1004.

The various components of the wireless communication device 1004 may be coupled together by one or more buses, which may include a power bus, a control signal bus, a status signal bus, a data bus, etc. For the sake of clarity, the various buses are illustrated in FIG. 8 as a bus system 1019.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4, 6 and 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reprocessing data in a radio protocol layer, comprising:
communicating using a first radio access technology;
reprocessing data in a processed data buffer of a first radio access technology protocol layer; and
forwarding the reprocessed data to an unprocessed data buffer.

2. The method of claim 1, further comprising transitioning to communicating using a second radio access technology, wherein the reprocessed data is forwarded for transmission on the second radio access technology.

3. The method of claim 1, further comprising detecting a trigger for a handover from the first radio access technology to a second radio access technology, wherein the unprocessed data buffer is part of a second radio access technology protocol layer.

4. The method of claim 3, further comprising forwarding data in an unprocessed data buffer of the first radio access technology protocol layer to the unprocessed data buffer of the second radio access technology protocol layer.

5. The method of claim 1, further comprising detecting a radio connection release, wherein the unprocessed data buffer is part of the first radio access technology protocol layer.

6. The method of claim 1, further comprising:
detecting a radio connection release; and
establishing a connection to a second radio access technology after the radio connection release, wherein the unprocessed data buffer is part of a second radio access technology protocol layer.

7. The method of claim 1, wherein reprocessing data in the processed data buffer comprises at least one of uncompressing compressed headers of IP packets, deciphering packets which have been ciphered for security protection, removing protocol layer specific headers, undoing segmentation and undoing concatenation.

8. The method of claim 1, wherein the data in the processed data buffer has passed through a packet data convergence protocol layer.

9. The method of claim 1, wherein the reprocessed data is in a same state as data provided to an unprocessed data buffer by a data services layer.

10. The method of claim 1, further comprising limiting the data that is reprocessed.

11. The method of claim 10, wherein limiting the data that is reprocessed comprises:
dropping all packets in the processed data buffer that have been in the processed data buffer longer than a drop packet threshold;
carrying over a time spent in the processed data buffer for each packet of the data forwarded to the unprocessed data buffer.

12. The method of claim 1, wherein the method is performed by a wireless communication device.

13. A wireless device configured for reprocessing data in a radio protocol layer, comprising:
a processor;
memory in electronic communication with the processor;
instructions stored in the memory, the instructions being executable by the processor to:
communicate using a first radio access technology;
reprocess data in a processed data buffer of a first radio access technology protocol layer; and
forward the reprocessed data to an unprocessed data buffer.

14. The wireless device of claim 13, wherein the instructions are further executable to transition to communicating using a second radio access technology, and wherein the reprocessed data is forwarded for transmission on the second radio access technology.

15. The wireless device of claim 13, wherein the instructions are further executable to detect a trigger for a handover from the first radio access technology to a second radio access technology, and wherein the unprocessed data buffer is part of a second radio access technology protocol layer.

16. The wireless device of claim 15, wherein the instructions are further executable to forward data in an unprocessed data buffer of the first radio access technology protocol layer to the unprocessed data buffer of the second radio access technology protocol layer.

17. The wireless device of claim 13, wherein the instructions are further executable to detect a radio connection release, and wherein the unprocessed data buffer is part of the first radio access technology protocol layer.

18. The wireless device of claim 13, wherein the instructions are further executable to:
detect a radio connection release; and
establish a connection to a second radio access technology after the radio connection release, wherein the unprocessed data buffer is part of a second radio access technology protocol layer.

19. The wireless device of claim 13, wherein the instructions executable to reprocess data in the processed data buffer comprise at least one of instructions executable to uncompress compressed headers of IP packets, instructions executable to decipher packets which have been ciphered for security protection, instructions executable to remove protocol layer specific headers, instructions executable to undo segmentation and instructions executable to undo concatenation.

20. The wireless device of claim 13, wherein the data in the processed data buffer has passed through a packet data convergence protocol layer.

21. The wireless device of claim 13, wherein the reprocessed data is in a same state as data provided to an unprocessed data buffer by a data services layer.

22. The wireless device of claim 13, wherein the instructions are further executable to limit the data that is reprocessed.

23. The wireless device of claim 22, wherein the instructions executable to limit the data that is reprocessed comprise instructions executable to:
drop all packets in the processed data buffer that have been in the processed data buffer longer than a drop packet threshold;
carry over a time spent in the processed data buffer for each packet of the data forwarded to the unprocessed data buffer.

24. The wireless device of claim 13, wherein the wireless device is a wireless communication device.

25. A wireless device configured for reprocessing data in a radio protocol layer, comprising:
means for communicating using a first radio access technology;
means for reprocessing data in a processed data buffer of a first radio access technology protocol layer; and
means for forwarding the reprocessed data to an unprocessed data buffer.

26. The wireless device of claim 25, further comprising means for detecting a trigger for a handover from the first radio access technology to a second radio access technology, wherein the unprocessed data buffer is part of a second radio access technology protocol layer.

27. The wireless device of claim 25, further comprising means for detecting a radio connection release, wherein the unprocessed data buffer is part of the first radio access technology protocol layer.

28. The wireless device of claim 25, further comprising:
means for detecting a radio connection release; and
means for establishing a connection to a second radio access technology after the radio connection release, wherein the unprocessed data buffer is part of a second radio access technology protocol layer.
